(19) United States
(12) Patent Application Publication
(10) Pub. No.: US 2022/0160157 A1
(43) Pub. Date: May 26, 2022

(54) Rug Fastening Device

(71) Applicant: Armin Prasch, Rochester, MN (US)

(72) Inventor: Armin Prasch, Rochester, MN (US)

(21) Appl. No.: 17/103,238

(22) Filed: Nov. 24, 2020

(51) Int. Cl. A47G 27/04; F16B 25/00

(52) U.S. Cl. CPC A47G 27/0418; F16B 25/0005

(57) ABSTRACT

A rug fastening device for attaching a rug to an installed carpet includes a fastener, which in turn comprises a plate and a screw. The screw is attached to a lower face of the plate and extends helically therefrom. The screw is pointed distal from the plate and thus can penetrate a substrate, such as a rug, a runner, or a mat. The fastener is one of a plurality of fasteners. Each fastener can be screwed through the substrate and into a carpet to affix the substrate thereto to prevent slipping and bunching of the substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fastening device and more particularly pertains to a new fastening device for attaching a rug to an installed carpet. The present invention discloses a helically shaped screw, which can be screwed through a rug into carpet and underlying padding to prevent the rug from slipping and bunching.

### (2) Description of Related Art Including Information Disclosed Under 37 CFR 1.97 and 1.98

The prior art relates to fastening devices, which may comprise fastening devices for attaching carpeting and rugs to flooring. The prior art also may comprise devices for securing floor mats to carpets in a vehicle, wherein the devices must be installed prior to the carpet. What is lacking in the prior art is a fastening device that can be utilized to attach a substrate to a carpet that has previously been installed over flooring.

### BRIEF SUMMARY OF THE INVENTION

An embodiment of the disclosure meets the needs presented above by generally comprising a fastener, which in turn comprises a plate and a screw. The screw is attached to a lower face of the plate and extends helically therefrom. The screw is pointed distal from the plate so that the screw is configured to penetrate a substrate, such as a rug, a runner, or a mat. The fastener is one of a plurality of fasteners, with each fastener being configured to be screwed through the substrate and into a carpet to affix the substrate thereto to prevent slipping and bunching of the substrate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a rug fastening device according to an embodiment of the disclosure.

FIG. 2 is an isometric perspective view of an embodiment of the disclosure.

FIG. 3 is a side view of an embodiment of the disclosure.

FIG. 4 is a bottom view of an embodiment of the disclosure.

FIG. 5 is an in-use view of an embodiment of the disclosure.

FIG. 6 is a cross-sectional view of an embodiment of the disclosure.

FIG. 7 is a box diagram of a method of the disclosure.

### DETAILED DESCRIPTION OF THE INVENTION

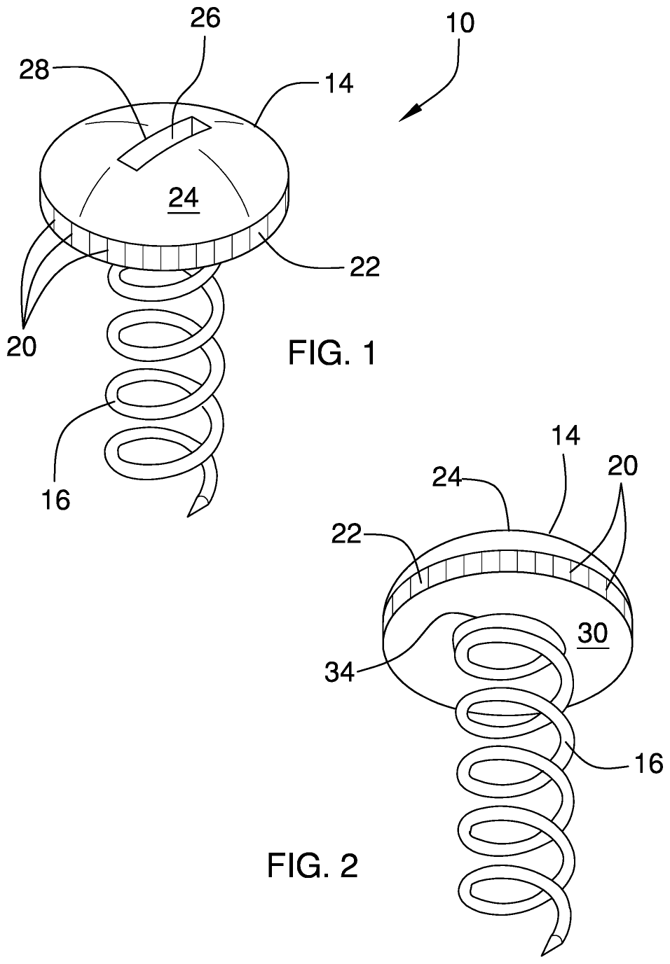

With reference now to the drawings, and in particular to FIGS. 1 through 7 thereof, a new fastening device embodying the principles and concepts of an embodiment of the disclosure and generally designated by the reference numeral 10 will be described.

As best illustrated in FIGS. 1 through 7, the rug fastening device 10 generally comprises a fastener 12, which in turn comprises a plate 14 and a screw 16. The plate 14 may be disc shaped, as shown in FIG. 1, or alternatively shaped, such as rectangular, oval, and the like. As will become apparent, the plate 14 may be shaped to complement a design of a rug 18 or a carpet. The plate 14 comprises metal, plastic, wood, or the like substantially rigid material. The plate 14 could be decorative or substantially transparent.

With the plate 14 being disc shaped, it also may have a plurality of groves 20 extending into a perimeter 22 thereof. The groves 20 are configured to enhance a grasp of digits of a hand of a user upon the plate 14.

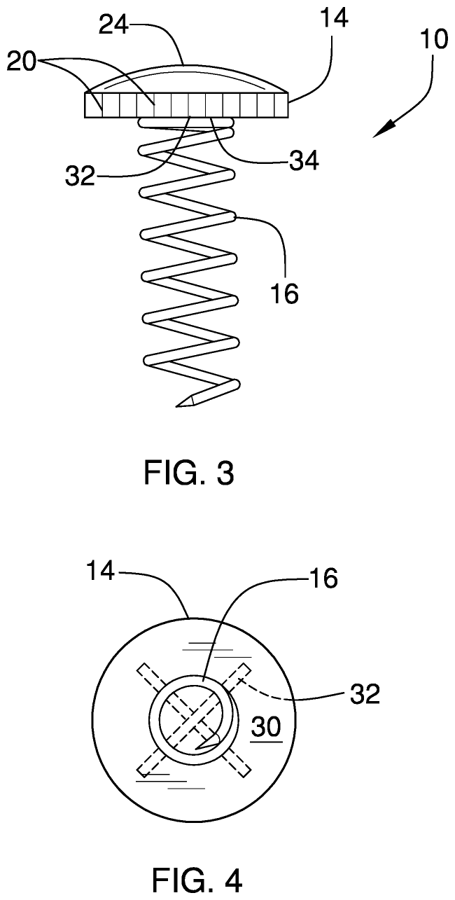

The plate 14 has an upper face 24, which may be domed, as shown in FIG. 3. The upper face 24 may have a cutout 26 extending thereinto. The cutout 26 is configured for insertion of a tool to turn the plate 14. The cutout 26 has a circumference 28, which may be rectangularly shaped, as shown in FIG. 1, so that the cutout 26 is configured for insertion of a tip of a standard screwdriver or a coin. The cutout 26 also may be alternatively shaped, such as cross shaped, star shaped, and the like, allowing for insertion of screwdriver tips having a complementary shape.

The screw 16 is attached to a lower face 30 of the plate 14 and extends helically therefrom. The screw 16 is pointed distal from the plate 14 so that the screw 16 is configured to penetrate a substrate, such as a rug 18, a runner, or a mat. The screw 16 resembles that of a corkscrew.

The present invention also anticipates the fastener 12 comprising connector 32, which is engaged to or embedded in the lower face 30 of the plate 14. The screw 16 is engaged to the connector 32 and extends therefrom so that the connector 32 is positioned to reinforce the screw 16. The connector 32 may be cross shaped, with an upper loop 34 of the screw 16 being engaged to the connector 32, as shown in FIGS. 3 and 4.

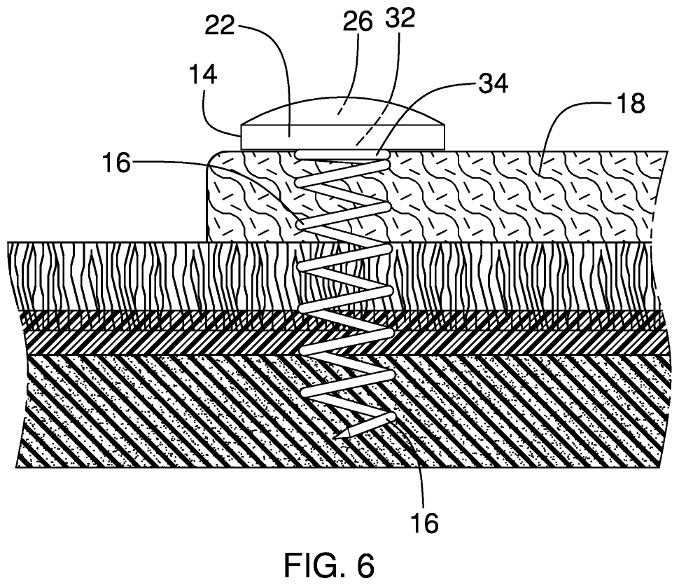

The fastener 12 is one of a plurality of fasteners 12, with each fastener 12 being configured to be screwed through the substrate and into a carpet to affix the substrate thereto, to prevent slipping and bunching of the substrate. Each fastener 12 may be configured to be screwed through both the substrate and the carpet into a pad positioned beneath the carpet, as shown in FIG. 6.

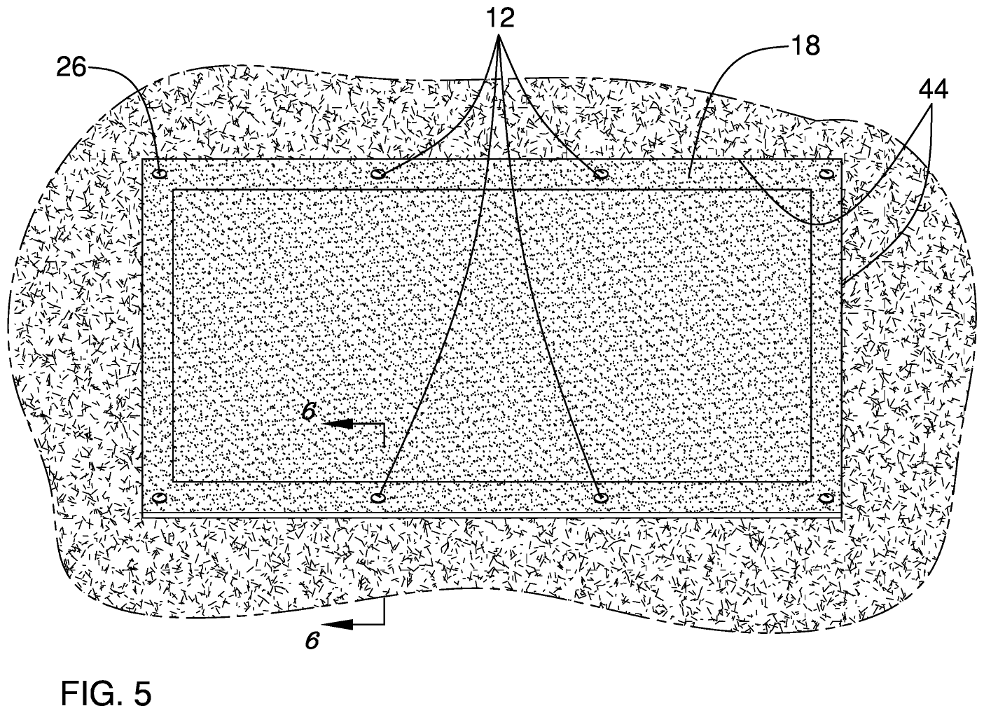

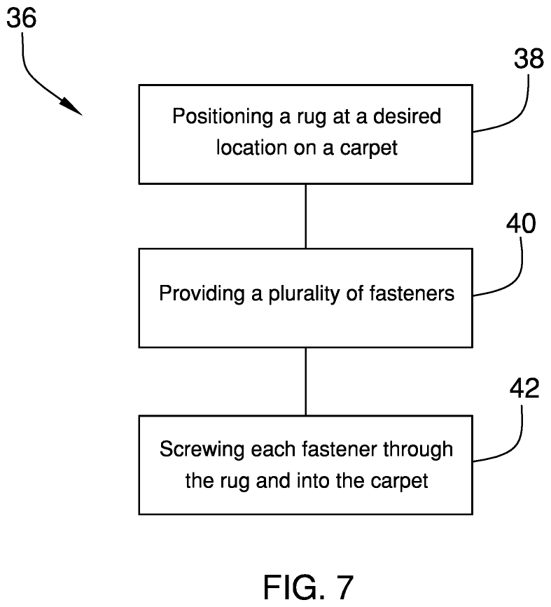

In use, the rug fastening device 10 allows for a method 36 of attaching a rug 18 to a carpet, as shown in FIG. 7. The method 36 comprises a first step 38 of positioning the rug 18 at a desired location on the carpet. A second step 40 of the method 36 comprises providing a plurality of fasteners 12. A third step 42 of the method 36 entails screwing each fastener 12 through the rug 18 and into the carpet to affix the substrate thereto. As shown in FIG. 5, the fasteners 12 may be screwed through the rug 18 proximate to edges 44 thereof. For larger rugs 18, respective fasteners 12 may be positioned distal from the edges 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A rug fastening device comprising:
a fastener comprising:
a plate, and
a screw attached to a lower face of the plate and extending helically therefrom, the screw being pointed distal from the plate, such that the screw is configured for penetrating a substrate; and
the fastener being one of a plurality of fasteners, wherein each fastener is configured for being screwed through the substrate and into a carpet for affixing the substrate thereto.

2. The rug fastening device of claim 1, wherein the plate is disc shaped.

3. The rug fastening device of claim 2, further including the plate having a plurality of groves extending into a perimeter thereof, wherein the groves are configured for enhancing a grasp of digits of a hand of a user upon the plate.

4. The rug fastening device of claim 2, further including the plate having an upper face, the upper face being domed.

5. The rug fastening device of claim 1, further including the plate having an upper face, the upper face having a cutout extending thereinto, wherein the cutout is configured for insertion of a tool for turning the plate.

6. The rug fastening device of claim 5, wherein the cutout has a circumference, the circumference being rectangularly shaped such that the cutout is configured for insertion a tip of a standard screwdriver.

7. The rug fastening device of claim 1, wherein the plate comprises metal, plastic, or wood.

8. The rug fastening device of claim 1, wherein the screw comprises metal or plastic.

9. The rug fastening device of claim 1, further including a connector engaged to or embedded in the lower face of the plate, the screw being engaged to the connector and extending therefrom, such that the connector is positioned for reinforcing the screw.

10. The rug fastening device of claim 9, wherein the connector is cross shaped, an upper loop of the screw being engaged to the connector.

11. The rug fastening device of claim 1, wherein each fastener is configured for screwing through the substrate and the carpet into a pad positioned beneath the carpet.

12. A method for attaching a rug to a carpet, the method comprising the steps of:
positioning a rug at a desired location on a carpet;
providing a plurality of fasteners, each fastener comprising:
a plate, and
a screw attached to a lower face of the plate and extending helically therefrom, the screw being pointed distal from the plate, such that the screw is configured for penetrating a substrate; and
screwing each fastener through the rug and into the carpet for affixing the substrate thereto.

13. A rug fastening device comprising:
a fastener comprising:
a plate, the plate being disc shaped, the plate having a plurality of groves extending into a perimeter thereof, wherein the groves are configured for enhancing a grasp of digits of a hand of a user upon the plate, the plate having an upper face, the upper face being domed, the upper face having a cutout extending thereinto, wherein the cutout is configured for insertion of a tool for turning the plate, the cutout having a circumference, the circumference being rectangularly shaped such that the cutout is configured for insertion a tip of a standard screwdriver, the plate comprising metal, plastic, or wood,
a screw attached to a lower face of the plate and extending helically therefrom, the screw being pointed distal from the plate, such that the screw is configured for penetrating a substrate, the screw comprising metal or plastic, and
a connector engaged to or embedded in the lower face of the plate, the screw being engaged to the connector and extending therefrom, such that the connector is positioned for reinforcing the screw, the connector being cross shaped, an upper loop of the screw being engaged to the connector; and
the fastener being one of a plurality of fasteners, wherein each fastener is configured for being screwed through the substrate and into a carpet for affixing the substrate thereto, each fastener being configured for screwing through the substrate and the carpet into a pad positioned beneath the carpet.
